(19) United States
(12) Patent Application Publication
(10) Pub. No.: US 2026/0241600 A1
(43) Pub. Date: Aug. 20, 2026

(54) MACHINE FOR CUTTING FABRIC

(71) Applicant: MORGAN TECNICA S.P.A., ADRO (IT)

(72) Inventor: Giulio TAMANZA, Adro (IT)

(21) Appl. No.: 19/160,641

(22) PCT Filed: Feb. 28, 2024
(86) PCT No.: PCT/IT2024/050043

§ 371 Date: Aug. 28, 2025

(30) Foreign Application Priority Data
Mar. 3, 2023 (IT) 102023000003873

(51) Int. Cl. B26D 7/01; D06H 7/00; F01D 15/10; F01D 25/30

(52) U.S. Cl. CPC B26D 7/018; D06H 7/00; F01D 15/10; F01D 25/30; F05D 2220/76

(57) ABSTRACT

Machine (1) for automatic cutting of fabric comprising:
a cutting plane (7) at an upper face (8) of a box (3) and comprising a plurality of pass-through openings;
a suction system (9) for drawing air from the interior (4) of the box;
a turbine (30) located downstream of the suction system and structured to extract energy from the exhaust air flow generated by the suction system and convert it into rotational mechanical energy;
an electric generator (40) mechanically coupled to the turbine (30) and structured to convert the rotational mechanical energy of the turbine into electrical energy.

### TECHNICAL FIELD OF THE INVENTION

The present invention relates to a machine for the automatic cutting of fabric or other flexible sheet materials (e.g., leather, synthetic leather, polymeric sheets, etc.).

### STATE OF THE ART

Machines for the automatic cutting of fabric capable of cutting fabrics, for instance, laid out in a single layer or arranged in stacks of overlapping layers (also referred to as “mattresses”), to create pieces of fabric cut according to cutting templates with given geometric shapes and dimensions, are known. These pieces are typically used to manufacture clothing items or others (e.g., car interiors, furnishings, etc.).

Typically, the fabric to be cut, whether in the form of a single layer or a stack, is placed on a cutting plane (realized, for example, by a conveyor belt), comprising a plurality of through openings. Typically, the cutting plane is positioned above a box, substantially constituting an upper face of the box.

The fabric to be cut is held in position during the cutting process by means of a depression (i.e., an air pressure lower than atmospheric pressure) generated inside the box, such depression exerting, through the openings, a retaining force on the fabric orthogonal to the cutting plane. The level of depression required can depend on the type of fabric, the number of layers, the type of cut, and/or the cutting execution mode.

The patent EP1951483B1 describes a known automatic cutting machine.

### SUMMARY OF THE INVENTION

In the field of the machines for the automatic cutting of fabric, the Applicant has found that to create the aforementioned depression, a suction system typically comprising at least one fan configured and installed to suck air from the interior of the said box is used.

The Applicant has faced the problem to improve the operational efficiency of a machine for the automatic cutting of fabric, for example in terms of the overall energy efficiency of the cutting machine.

According to the Applicant, the aforementioned problem is solved by a machine for the automatic cutting of fabric according to the attached claims and/or having one or more of the following features.

According to an aspect, the invention relates to a machine for the automatic cutting of fabric, the machine comprising:
a box having an open upper face;
a cutting plane at said upper face of the box, said cutting plane comprising a plurality of through openings;
a suction system structured to suck air from an interior of said box to generate a pressure difference at opposite faces of said cutting plane, said suction system generating a flow of exhaust air;
a turbine located downstream of the suction system and structured to extract energy from said flow of exhaust air and convert it into rotational mechanical energy;
an electric generator mechanically coupled to said turbine and structured to convert said rotational mechanical energy of said turbine into electrical energy.

The terms “downstream” and “upstream” are to be understood as referring to the direction of the air flow(s) generated by the suction system.

In efforts to solve the aforementioned problem, the Applicant has found that, during the operation of cutting machines (especially at machine start-up or when an increase in depression is required), a significant flow of air, due to the exhaust of the air sucked by the suction system, is expelled from the cutting machines themselves (e.g., from the bottom of the machines) and simply dispersed into the environment.

However, this flow of exhaust air can contain a significant energy potential, currently wasted by known cutting machines.

The Applicant has therefore realized that such a flow of exhaust air can be directed towards a turbine (e.g., a turbomachinery capable of collecting the energy associated with the motion of a fluid, e.g., kinetic and/or enthalpic energy, and of transforming that energy into rotational mechanical energy) coupled to an electric generator for the generation of electrical energy. This latter can then be reused, for example directly for the cutting machine itself and/or by feeding back into the grid, benefiting an overall improvement in the operational efficiency of the machine.

The present invention in the aforementioned aspect may have one or more of the following preferred features.

Preferably, said machine includes a load-bearing structure, which more preferably realizes at least in part said box and an (additional) compartment (external to said box), said compartment being placed alongside said box along a main direction of development of the machine (coinciding with a direction of advancement of the conveyor belt).

Preferably, said suction system is housed in said load-bearing structure.

Preferably, said machine comprises an exhaust pipe in fluid communication with said suction system to convey said flow of exhaust air. In this way, the flow of air discharged by the suction system is conveyed in an orderly and rational manner to a desired point, to avoid disturbances to operators and/or to reduce noise.

Preferably, said suction system comprises at least one suction fan, more preferably housed in said compartment, in fluid communication with the interior of said box and, more preferably, with said exhaust pipe.

Preferably, said exhaust pipe comprises (or consists only of) a first rectilinear section, more preferably horizontal. This facilitates the stabilization of the air flow, for example, to achieve a flow with a laminar motion regime.

Preferably, said first section has a length greater than or equal to 30 cm, and/or less than or equal to 300 cm, more preferably less than or equal to 250 cm. In this way, the first section is sufficiently extended to stabilize the air flow, without exceeding in the overall dimensions of the machine.

Preferably, said first section is (e.g., entirely) located within (an encumbrance of) said load-bearing structure, more preferably is housed in said compartment. This limits the total encumbrance of the machine.

In one embodiment, said exhaust pipe comprises a second section, placed downstream of said first section, more preferably rectilinear and, even more preferably, vertical (with upward development relative to the flow direction).

Preferably, said exhaust pipe comprises a curved connecting section connecting with flow continuity said first and second section. In large cutting machines, typically sized to handle large volumes of fabric to be cut, such second section (which exceeds the encumbrance of the machine's load-bearing structure) creates a chimney for discharging the significant air flows away from operators.

Preferably, said second section has a length greater than or equal to 100 cm, and/or less than or equal to 400 cm, more preferably less than or equal to 300 cm.

Preferably, said second section has a length greater than or equal to three times a diameter of a cross-section of said second section. In this way, at the exit of the second section, the exhaust air flow is substantially laminar.

Preferably, said turbine and said electric generator are housed within (an encumbrance of) said load-bearing structure, more preferably are housed in said compartment. This arrangement provides space for the turbine and the generator, without altering the total encumbrance of the machine.

Preferably, said turbine is operationally coupled to said exhaust pipe. This allows the turbine to be invested with the exhaust air flow suitably structured, in order to maximize the efficiency of the turbine.

Preferably, said exhaust pipe has a circular cross-section. This facilitates the direction of the air flow and the coupling with the turbine.

In a preferred embodiment, said turbine is positioned (immediately) upstream of said exhaust pipe (e.g., of said first section), more preferably is interposed between said suction system (e.g., said fan) and said exhaust pipe (e.g., said first section), even more preferably is adjacent to said fan. The Applicant has verified that this arrangement results in high energy recovery as the air flow, just exiting the fan, has a high flow velocity and also has gone through a minimal (if any) number of changes in the conduit cross-sections (at which the air flow may experience pressure losses).

Moreover, this position allows for easy accessibility, for example, without the need to dismantle the first section of the conduit.

In an embodiment (e.g., alternative to the aforementioned preferred embodiment), said turbine is positioned (e.g., along said exhaust pipe) at an end of said first section downstream relative to a direction of said air flow (and preferably an opposite end of said first section is in correspondence with said suction fan). In this position, the air flow, having passed through the first section, is less turbulent compared to the exit from the fan, with positive benefits in terms of turbine efficiency.

In a further embodiment (e.g., alternative to, or in combination with one of the two aforementioned embodiments), said turbine is positioned (e.g., along said exhaust pipe) at an end of said second section downstream relative to a direction of said air flow (i.e., at an upper end of the chimney). The Applicant believes that a greater length of the rectilinear section of the exhaust pipe upstream of the turbine (made possible by the vertical section of the exhaust pipe) allows achieving the desired laminar flow regime of the air flow.

Preferably, said exhaust pipe comprises (e.g., said first and/or second section is entirely realized by) an exhaust flow silencer. This also simultaneously improves acoustic comfort.

Preferably, said turbine is an axial turbine (preferably with the turbine axis coinciding with a local axis of the exhaust pipe, e.g., the first section or the second section).

This makes the turbine particularly suitable for easy insertion into the exhaust pipe.

Preferably, said turbine is a reaction turbine. This optimizes energy efficiency.

Preferably, said turbine is a single-stage turbine, more preferably comprising a fixed stator (e.g., rigidly attached to said exhaust pipe) and a rotor rotatable around said axis. Preferably, said stator includes a fixed frame and a stator element rigidly attached to said frame and comprising a first plurality of fixed radial blades (typically angularly distributed on a plane orthogonal to said axis). Preferably, said rotor includes a rotatable shaft around said axis and a second plurality of radial blades fixed to said shaft (typically angularly distributed in the orthogonal plane). Preferably, said stator element is positioned upstream of said rotor relative to the direction of the air flow. This allows achieving the desired energy yield. Preferably, said first and/or said second plurality of blades are shaped to discharge from said turbine (from said rotor) a substantially axial air flow. In other words, the shape of the stator and rotor blades is designed so that the velocity triangles exiting the rotor return a component of air flow motion that is substantially axial (e.g., within the range of +/−15°, more preferably +/−10°, with respect to the axial direction). This allows optimizing the discharge while avoiding significant modification of the machine's geometry.

Preferably, said electric generator includes a static portion and a rotating portion mechanically coupled to said turbine, more preferably to a (shaft of the) rotor of said turbine. Preferably, one of said static portion and rotating portion (together forming a magnetic circuit) is structured to produce a magnetic field, and the other of said static portion and rotating portion includes an electrical winding (in which said magnetic field induces an electric current). This effectively generates electricity.

In one embodiment, said electric generator is (entirely) located outside of said exhaust pipe. Preferably, the rotating portion of the generator is mechanically coupled to said rotor shaft via a belt. This allows the size of the electric generator to be independent of the dimensions of the exhaust pipe, enabling the generator to be appropriately sized.

In an alternative embodiment, said electric generator is (entirely) located inside said exhaust pipe, more preferably in an axial position. Preferably, the static portion is rigidly attached to said exhaust pipe (e.g., fixed to the stator in an axial position), and the rotating portion is rigidly attached to said (shaft of the) rotor in a suitable manner. This reduces the footprint occupied by the generator and utilizes the exhaust pipe as the supporting structure for the generator.

In one embodiment, said machine comprises (at least) an additional turbine and an additional electric generator, wherein said turbine is positioned upstream of the exhaust pipe (and/or at the downstream end of the first section), as described above, and said additional turbine is positioned at the end of the second section, as described above. In other words, the machine can include two (or up to three) turbine-electric generator assemblies (each as described above) in the two (or three) aforementioned positions, for a higher percentage of potentially recovered energy.

Preferably, said machine includes, in an upper portion of said box and housed inside said box, a conveyor belt that forms said cutting plane (e.g., by a respective portion of the belt disposed currently on top). Typically, this conveyor belt serves as support for the fabric to be cut during cutting and also as a means for moving the fabric to be cut or already cut before and after the cutting operation.

Preferably, said cutting plane is formed by the ends of a plurality of flexible elongated elements, said elongated elements extending orthogonally to the cutting plane (e.g., vertically). In this way, the cutting plane can support the fabric to be cut and at the same time allow the penetration of the blade with minimal or no damage to the cutting plane (which may be limited to only a few vertical elements).

Preferably, said machine includes an overhead bridge over said cutting plane and movable along the main development direction of the machine, and a cutting head supported by the bridge and movable along the bridge. Preferably, said cutting head includes a cutting device (e.g., a blade). This allows the blade to move across the entire cutting plane.

### BRIEF DESCRIPTION OF THE DRAWINGS

FIG. 1 shows partially and schematically a side view of a machine for the automatic cutting of fabric according to the present invention.

FIG. 2 shows partially and schematically a front view of the machine for the automatic cutting of fabric shown in FIG. 1.

FIGS. 3 and 4 show partially and schematically a section of a respective portion of the machine shown in FIG. 1.

### DETAILED DESCRIPTION OF CERTAIN EMBODIMENTS OF THE INVENTION

The features and advantages of the present invention will be further elucidated by the following detailed description of some embodiments of the present invention, presented by way of example and not by way of limitation, with reference to the attached figures (purely schematic and not to scale).

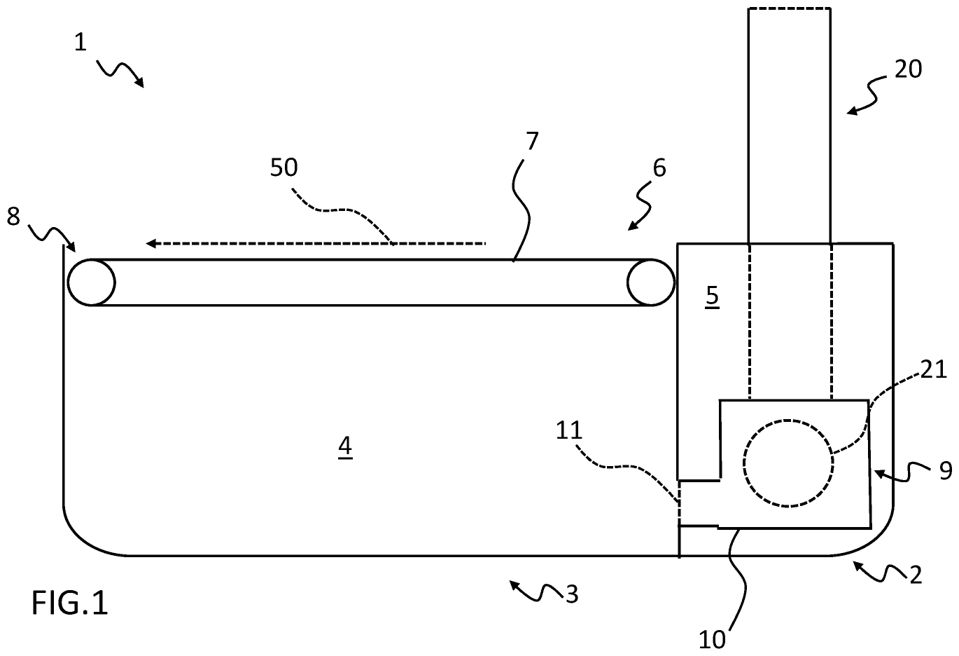

FIG. 1 schematically depicts a side view of a machine 1 for the automatic cutting of (not shown) fabric or other flexible sheet material, such as leather, synthetic leather, polymer sheets.

The machine has a main development direction 50, coinciding with the direction of advancement of the conveyor belt (indicated by the dashed arrow).

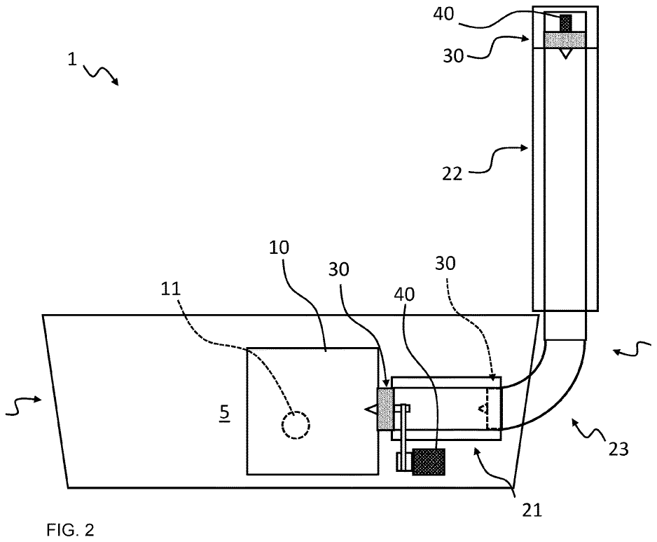

FIG. 2 schematically shows the machine 1 in a frontal view, with the main development direction 50 orthogonal to the plane of the figure. For illustrative purposes, the figures show internal elements of the machine's structure, which are normally covered by the structure itself or appropriate casings.

The machine comprises a supporting structure 2 (shown only schematically), which partially forms a box 3 with an interior 4 and an open upper face 8, and an external compartment 5 adjacent to the box along the main development direction 50.

Preferably, the machine includes, in an upper portion of the box and housed inside the box, a conveyor belt 6 whose upper surface (current) forms a cutting plane 7 designed to support the fabric during cutting.

In alternative embodiments, the cutting plane can be of a static type.

Preferably, the conveyor belt 6 is covered by a plurality of flexible elongated elements (not shown) whose coplanar ends form the cutting plane. The cutting plane (and the entire conveyor belt 6) is breathable to airflow, thanks to a plurality of openings passing through the conveyor belt.

The machine comprises a bridge overhanging the cutting plane and movable along the main development direction 50 of the machine and a cutting head supported by the bridge and transversely movable along the bridge. The cutting head comprises a cutting device (e.g. a vertically oscillating blade). These components, as well as their actuation systems, electronics, and control logic, are not shown and further described here as they may be of a known type.

The machine 1 comprises a suction system 9 structured to draw air from the interior 4 of the box 3 to generate a pressure difference at opposite sides of the cutting plane 7. Typically, the aspiration of air from the box creates a depression below the cutting plane 7 to keep the fabric pressed towards the cutting plane 7, advantageously preventing the formation of folds or wrinkles that could cause errors in the fabric cutting process. The suction system 9 exemplarily comprises a fan 10 (shown purely schematically as per se well-known) housed in the compartment 5 and in fluid communication (via suitable ducts) with the interior 4 of the box (through an opening 11 made in the box's wall) and with the exhaust duct described below.

The machine 1 includes an exhaust duct 20, circular in cross-section, coupled to the suction system 9 to convey a discharge airflow from the suction system.

The machine 1 comprises a turbine 30 located upstream and/or along the exhaust duct 20, structured to extract energy from the discharge airflow and convert it into rotational mechanical energy and an electric generator 40 mechanically coupled to the turbine 30 and structured to convert the rotational mechanical energy of the turbine into electrical energy.

Preferably, the turbine 30 is an axial turbine, with axis coinciding with the local axis of the exhaust duct.

Preferably, the turbine is a single-stage turbine and comprises a stator 31 that includes a fixed frame rigidly attached to the exhaust duct and a stator element 32 rigidly attached to the frame, including a first plurality of radial blades angularly distributed on the plane orthogonal to the axis. The turbine, e.g., the stator, may include a flow deflector 34 upstream, e.g., in the form of a bell, and more preferably, a flow deflector 35 downstream, e.g., in a conical axial shape.

The turbine further comprises, downstream of the stator, a rotor 33 comprising a rotatable shaft around the axis and a second plurality of radial blades fixed to the shaft and angularly distributed on the orthogonal plane.

The electric generator as such can be of a known type itself.

Preferably, the exhaust pipe comprises a first section 21 straight and horizontal, for example, approximately 50 cm long, entirely housed in the compartment 5.

In an embodiment, the exhaust pipe 20 comprises a second section 22, located downstream of the first section, straight and vertical, extending upwards, for example, approximately 150 cm long. Preferably, the exhaust pipe includes a curved connecting section 23 that fluidly connects the first and second sections. The second section 22 (and a substantial part of the curved connecting section 23) extends outside the encumbrance of the load-bearing structure 2. Exemplarily, the first and second section have a cross-section diameter of approximately 20 cm.

Preferably, the first section 21 and/or the second section 22 is/are entirely made of a respective flow silencer, shown only schematically and not further described as it is known per se.

In an embodiment not shown, the exhaust pipe 20 consists only of the first section 21, optionally combined with the curved connecting section 23.

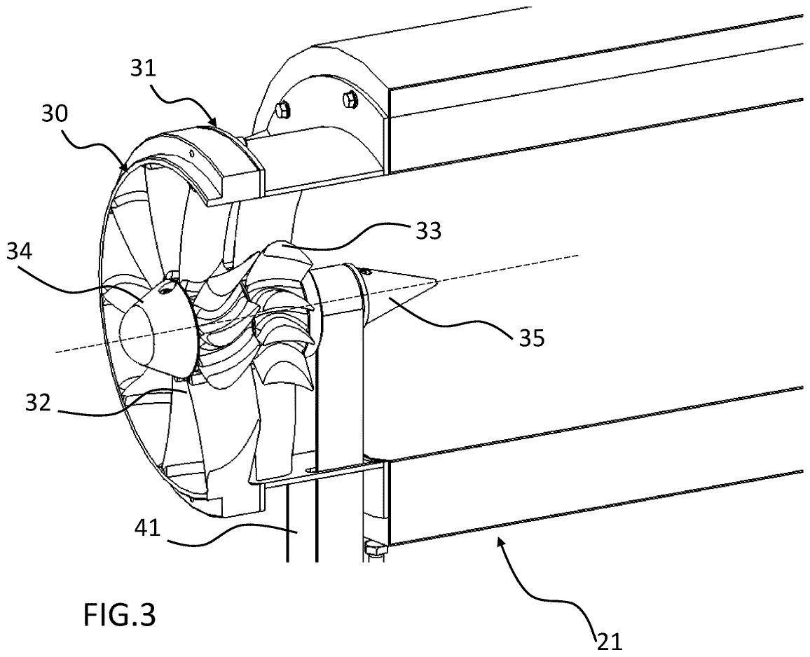

In an embodiment (e.g., shown in FIG. 2 with a solid line and in FIG. 3), the turbine 30 is located immediately upstream of the first section 21 of the exhaust pipe 20, positioned between the fan of the suction system (immediately downstream of the fan) and the first section 21. Preferably, the respective electric generator 40 is entirely located outside the exhaust pipe, where a rotatable portion of the generator is mechanically coupled to a rotor shaft of the turbine via a belt 41.

In one embodiment (exemplarily shown in dashed line in FIG. 2), the turbine 30 (with the respective generator, not shown, e.g., located outside the exhaust pipe) can be located at one end of the first section 21 downstream with respect to the direction of the exhaust air flow.

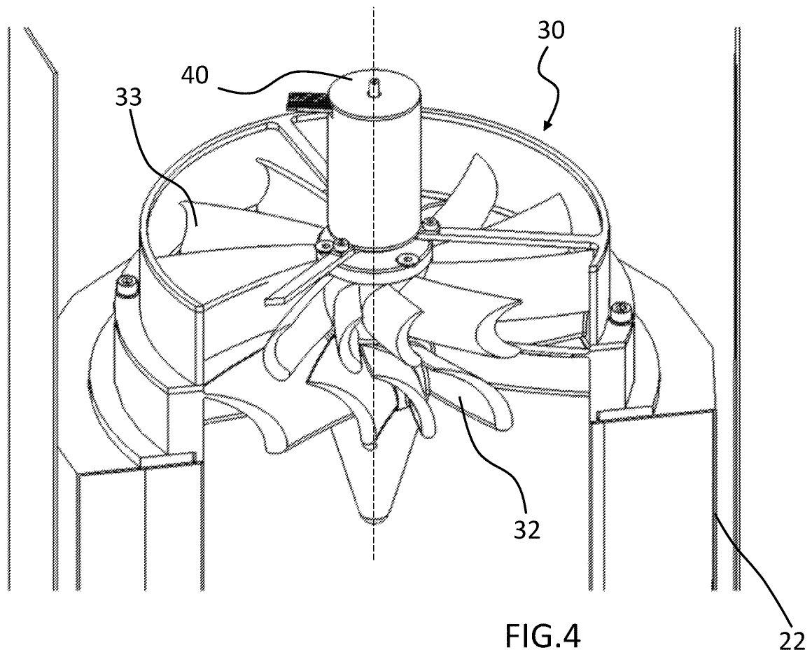

In another embodiment (e.g., shown in FIG. 2 with a solid line and in FIG. 4), the turbine 30 (and the electric generator 40) can be located at the upper end of the second section, downstream with respect to the direction of the exhaust air flow.

Preferably, the electric generator 40 is entirely located inside the exhaust pipe 20, in an axial position, wherein the stationary portion of the generator is rigidly attached (e.g., via three mechanical arms) to the frame of the stator 31 in an axial position, and the rotatable portion is rigidly attached to the rotor 33 shaft in a coaxial manner.

In FIG. 2, two turbines with their respective electric generators are shown with solid line, and an additional turbine is shown with dashed line.

In the preferred embodiment of the present invention (also for reasons of cost-benefit trade-off), it is envisaged the presence of one and only one turbine with its respective generator, and this single turbine can be respectively located in any of the positions described and shown here. However, the present invention also contemplates embodiments that involve the simultaneous presence of two (or three) distinct turbines, each with its respective generator, for example, located respectively in the positions described and shown here.

1. A machine for automatic cutting of fabric, the machine comprising:
a box having an upper face open,
a cutting plane at said upper face of the box, said cutting plane comprising a plurality of through openings;
a suction system structured to suck air from an interior of said box to generate a pressure difference at opposite faces of said cutting plane, said suction system generating a flow of exhaust air;
a turbine located downstream of the suction system and structured to extract energy from said flow of exhaust air and convert it into rotational mechanical energy; and
an electric generator mechanically coupled to said turbine and structured to convert said rotational mechanical energy of said turbine into electrical energy.

2. The machine according to claim 1, comprising an exhaust pipe in fluid communication with said suction system to convey said flow of exhaust air and a load-bearing structure, which at least partially realizes said box and a compartment outside said box, said compartment being placed alongside said box along a main direction of development of the machine, wherein said suction system is housed in said load-bearing structure, wherein said suction system comprises at least one suction fan housed in said compartment, in fluid communication with the interior of said box and with said exhaust pipe, wherein said exhaust pipe has a circular cross-section, wherein said exhaust pipe comprises a first rectilinear section, horizontal and having a length greater than or equal to 30 cm, and less than or equal to 300 cm, and wherein said turbine is operationally coupled to said exhaust pipe.

3. The machine according to claim 2, wherein said turbine is located upstream of said exhaust pipe, interposed between said suction system and said exhaust pipe, and wherein said turbine and said electric generator are housed in said compartment.

4. The machine according to claim 2, wherein said exhaust pipe comprises a second section, placed downstream of said first section, rectilinear and vertical with upward development, wherein said second section has a length greater than or equal to 100 cm, and less than or equal to 400 cm, wherein said second section has length greater than or equal to three times a diameter of a cross-section of said second section, wherein said exhaust pipe comprises a curved connecting section connecting with flow continuity said first and second section, and wherein each of said first and/or second section comprises, or is entirely realized by, an exhaust flow silencer.

5. The machine according to claim 4, wherein said turbine and said electric generator are arranged at one upper end of said second section downstream with respect to a direction of said flow of exhaust air, wherein said electric generator is entirely located inside said exhaust pipe in an axial position, wherein a static portion of the electric generator is rigidly attached to said exhaust pipe, and wherein a rotating portion of the electric generator is rigidly attached to a rotor of the turbine in a coaxial manner.

6. The machine according to claim 1, wherein said turbine is an axial turbine with turbine axis coinciding with a local axis of the exhaust pipe, wherein said turbine is a reaction turbine, and wherein said turbine is a single-stage turbine comprising a stator fixed and rigidly attached to said exhaust pipe and a rotor rotatable around said turbine axis.

7. The machine according to claim 6, wherein said stator comprises a fixed frame and a stator element rigidly fixed to said frame and comprising a first plurality of fixed radial blades angularly distributed in a plane orthogonal to said turbine axis and wherein said rotor comprises a shaft rotating around said turbine axis and a second plurality of radial blades fixed to said shaft and angularly distributed in said orthogonal plane, wherein said stator element is located upstream of said rotor with respect to said direction of said air flow.

8. The machine according to claim 7, wherein said first and/or second plurality of blades is shaped to generate a substantially axial air flow in output from said turbine.

9. The machine according to claim 1, wherein said electric generator comprises a static portion and a rotating portion mechanically coupled to a rotor of said turbine, wherein said static and rotating portion form a magnetic circuit, wherein said electric generator is entirely located outside said exhaust pipe and wherein said rotating portion is mechanically coupled to a rotor of the turbine by means of a belt.

10. The machine according to claim 1, comprising, in an upper portion of said box and housed in said interior of said box, a conveyor belt which realizes said cutting plane and comprising a gantry above said cutting plane and movable along a main development direction of the machine and a cutting head supported by the gantry and movable along the gantry, wherein said cutting head comprises a cutting device.
